(19) United States
(12) Patent Application Publication
(10) Pub. No.: US 2014/0097392 A1
(43) Pub. Date: Apr. 10, 2014

(54) LIQUID COATING COMPOSITIONS OF POLYMER MATRIX RESINS WITH PHOTOCHROMIC DYES AND FILMS MADE THEREFROM

(71) Applicant: E I DU PONT DE NEMOURS AND COMPANY, Wilmington, DE (US)

(72) Inventors: CHARLES T. BERGE, Earleville, MD (US); C. Chad Roberts, Hockessin, DE (US)

(73) Assignee: E I DU PONT DE NEMOURS AND COMPANY, Wilmington, DE (US)

(21) Appl. No.: 13/645,987

(22) Filed: Oct. 5, 2012

(51) Int. Cl. G02B 5/23

(52) U.S. Cl. 252/586

(57) ABSTRACT

In a first aspect, a liquid coating composition includes a blend of a polymer matrix resin and a photochromic dye. The polymer matrix resin includes silane groups, and at least 50% of the silane groups in the polymer matrix resin are at terminal positions.

In a second aspect, a film includes a photochromic dye in a polymer matrix. The polymer matrix includes at least one allophanate or biuret group, and the at least one allophanate or biuret group includes a silane moiety.

In a third aspect, an ophthalmic lens includes a film, and the film includes a photochromic dye in a polymer matrix. The polymer matrix includes at least one allophanate or biuret group, and the at least one allophanate or biuret group includes a silane moiety.

### BACKGROUND INFORMATION

1. Field of the Disclosure

This disclosure relates to liquid coating compositions of polymer matrix resins with photochromic dyes and films made therefrom.

2. Description of the Related Art

Photochromic dyes, i.e., photochromic compounds, have been used to prepare articles which change color under the influence of ultra-violet (UV) radiation and change back to their original color by removing the source of the UV radiation. Photochromic dyes are used in ophthalmic applications to provide corrective lenses that can be used continuously in both light and dark environments. These lenses are typically clear or lightly tinted. When exposed to UV radiation, like that contained in sunlight, the lenses become dark as the photochromic dye converts from a dormant ‘clear or colorless’ configuration to a highly colored configuration. The general mechanism for the reversible color change, exhibited by different categories of photochromic compounds each having their own particular color, has been described by John C. Crane in “Chromogenic Materials (Photochromic)”, Kirk-Othmer Encyclopedia of Chemical Technology, Fourth Edition, 1993, pp. 321-332. Spiropyrans are a common class of photochromic compounds that, when exposed to UV radiation, undergo an electrocyclic transition which transforms the colorless ‘spiro’ compound to a highly colored ‘conjugated closed ring’ compound. This is a reversible process where the conjugated colored specie will transform back to the colorless specie by a thermal induced mechanism upon removal of the UV radiation source.

For a photochromic dye, this electrocyclic transition of the photochromic compound requires an environment, on a molecular scale, that will allow the reversibility to take place. This environment may be provided by interstitial space within a polymer matrix. The characteristics of a polymer matrix can, thus, be an important determinant of the activity and color of a photochromic dye. The flexibility of the polymer chain segments in the polymer matrix surrounding the photochromic compound, establishes the local viscosity and hence mobility of the photochromic compound. Being able to achieve a polymer matrix that will allow the optimum transition activity is one of the key factors in the design of such a polymeric composition. In “New Aspects of Photochromism in Bulk Polymers”, Photographic Science and Engineering, 1979. pp 183-190, the author Claus D. Eisenbach points to the slow rate of photochromic dye activation and fade as a major shortcoming of these dyes in polymer matrices. Commercial applications of photochromic dyes embedded in solid polymers, particularly in plastic ophthalmic lenses, have been advanced with a better understanding of the nature and consequence of the polymer matrix.

As plastic lenses made of polycarbonates (PCs) or allyl diglycol carbonates (ADCs) became popular due to their weight advantages over glass, a race to discover plastics that could be used as lens materials with higher refractive index has evolved. At the same time, the use of photochromic dyes that were initially infused into the plastic lenses or polymerized “en masse” into the plastic lens underwent a difficult transition to photochromic dyes incorporated as a separate film layer on the front side of the plastic lenses. This provided the manufacturer with the latitude of using a set of dyes to achieve any desired color transition without having to modify the “bulk lens matrix”. Polymerizable and/or crosslinkable material could then contain the dyes of choice (color) for all manner of applications. Plastic ophthalmic lenses of differing composition, shape, thickness, refractive index, density, etc. have been enabled by this advance in the use of photochromic film layers.

Improvements in liquid coating compositions containing photochromic dyes and film made from these coatings, as well as methods for applying photochromic coatings which have compatibility with lens materials are still needed. In addition, a hard film containing a photochromic dye would also provide a sound foundation to which hard over-coating materials can adhere.

### SUMMARY

In a first aspect, a liquid coating composition includes a blend of a polymer matrix resin and a photochromic dye. The polymer matrix resin includes silane groups, and at least 50% of the silane groups in the polymer matrix resin are at terminal positions.

In a second aspect, a film includes a photochromic dye in a polymer matrix. The polymer matrix includes at least one allophanate or biuret group, and the at least one allophanate or biuret group includes a silane moiety.

In a third aspect, an ophthalmic lens includes a film, and the film includes a photochromic dye in a polymer matrix. The polymer matrix includes at least one allophanate or biuret group, and the at least one allophanate or biuret group includes a silane moiety.

The foregoing general description and the following detailed description are exemplary and explanatory only and are not restrictive of the invention, as defined in the appended claims.

### DETAILED DESCRIPTION

### Definitions

The following definitions are used herein to further define and describe the disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the terms “a” and “an” include the concepts of “at least one” and “one or more than one”.

When the term “about” is used in describing a value or an end-point of a range, the disclosure should be understood to include the specific value or end-point referred to.

The term “copolymer” is used herein to refer to polymers containing copolymerized units of two different monomers (a dipolymer), or more than two different monomers.

The term “lens” is used herein to refer to an article that may be characterized by its optical properties, and may both transmit and refract light in the visible spectrum. A lens may include one or more components, layers, films or coatings, each of which may provide certain optical, chemical and/or physical properties to the overall lens. An ophthalmic lens is a lens intended for use in conjunction with an eye, most commonly used to alter or “correct” vision.

As used herein, the term “moisture curable” is intended to refer to a reaction between two reactive groups that requires water as a co-reactant. Water can react with one or both of the reactive groups, followed by reaction of the two reactive groups with each other. For example, the coupling reaction between two alkoxysilane-containing functional groups may be carried out in the presence of water. In the simplest form of this coupling reaction, water can hydrolyze one alkoxy group to a hydroxyl group forming an activated species, a hydroxysilane. The hydroxysilane then reacts in a condensation reaction with a second alkoxysilane to form a Si—O—Si bond sequence with the formation of an alcohol.

The term “photochromic dye” is used herein to refer to a compound capable of undergoing a photochemical reaction that affects its absorption of electromagnetic radiation. For ophthalmic applications, the affected absorption is typically in the visible range.

The term “polymer matrix” is used herein to refer to a polymer structure wherein the polymer structure is defined by polymer chain(s) and the space in and around the polymer chain(s), i.e. interstitial space. For example, a polymer matrix may include interstitial space into which a photochromic dye may be incorporated. When a photochromic dye is described as being “in” a polymer matrix, it is meant to describe a photochromic dye that is part of the interstitial space in and around the polymer chains of the polymer matrix. The photochromic dye need not be fully contained or bounded by the space within the polymer matrix. Furthermore, the polymer matrix may accommodate the photochromic dye in such a way that the dye is able to undergo a photochemical reaction without being significantly hindered by the polymer matrix itself. The term “polymer matrix resin” is used herein to refer to a polymer that, upon curing, forms a polymer matrix.

As used herein, the term “reactive solvent” is intended to refer to a material that reacts with functional groups of a polymer to promote crosslinking and/or chain extension. In one embodiment, a reactive solvent can be included in a liquid coating composition as a single component or as part of a multi-component system that solubilizes other compounds in the liquid coating composition and reacts to promote crosslinking and/or chain extension of the polymer.

As used herein, the term “terminal position” is intended to refer to the end positions of a polymer backbone and may be contrasted with pendant positions along the polymer backbone. On a branched polymer, there may be three or more terminal positions (i.e., one terminal position for each end of the backbone and the terminal ends of the branches). A terminal position may accommodate one or more functional groups that may affect the properties of the polymer. For example, a single terminal position on a polymer might incorporate one or more silane groups that improve the adhesion of the polymer to a substrate. A terminal position may also accommodate a functional group, such as an allophanate or biuret group, that may further accommodate additional functional groups or moieties.

In a first aspect, a liquid coating composition includes a blend of a polymer matrix resin and a photochromic dye. The polymer matrix resin includes silane groups, and at least 50% of the silane groups in the polymer matrix resin are at terminal positions.

In one embodiment of the first aspect, the polymer matrix resin further includes at least one allophanate or biuret group, and the at least one allophanate or biuret group is at a terminal position. In a more specific embodiment, the at least one allophanate or biuret group includes a silane moiety.

In another embodiment of the first aspect, the polymer matrix resin includes a homopolymer or copolymer selected from the group consisting of polyesters, polyethers, polycarbonates, polyurethanes, polyacrylates, polyolefins, polyamides, and mixtures thereof. In a more specific embodiment, the polymer matrix resin includes a polyester.

In yet another embodiment of the first aspect, the photochromic dye is selected from the group consisting of pyrans, oxazines, fulgides, fulgimides, diarylethenes and mixtures thereof.

In a further embodiment of the first aspect, at least 80% of the silane groups in the polymer matrix resin are at terminal positions. In a more specific embodiment, at least 95% of the silane groups in the polymer matrix resin are at terminal positions.

In still another embodiment of the first aspect, the liquid coating composition further includes a reactive solvent. In a more specific embodiment, the reactive solvent is selected from the group consisting of 1,2-bis(triethoxysilyl)ethane, 3-ureidopropyltrimethoxysilane, 3-glycidoxypropyldimethoxymethylsilane, cyclohexylmethyldimethoxysilane, ureidomethyltrimethoxysilane, N-cyclohexylaminomethyltriethoxysilane, propyltrimethoxysilane, and mixtures thereof.

In still yet another embodiment of the first aspect, the liquid coating composition further includes an additive selected from the group consisting of light stabilizers, anti-oxidants, surfactants, adhesion promoters, crosslinkers, catalysts, and mixtures thereof.

In a further embodiment of the first aspect, the liquid coating composition is moisture curable.

In a second aspect, a film includes a photochromic dye in a polymer matrix. The polymer matrix includes at least one allophanate or biuret group, and the at least one allophanate or biuret group includes a silane moiety.

In one embodiment of the second aspect, the polymer matrix includes a homopolymer or copolymer selected from the group consisting of polyesters, polyethers, polycarbonates, polyurethanes, polyacrylates, polyolefins, polyamides, and mixtures thereof. In a more specific embodiment, the polymer matrix includes a polyester.

In another embodiment of the second aspect, the photochromic dye is selected from the group consisting of pyrans, oxazines, fulgides, fulgimides, diarylethenes and mixtures thereof.

In yet another embodiment of the second aspect, the film further includes an additive selected from the group consisting of light stabilizers, anti-oxidants, surfactants, adhesion promoters, crosslinkers, catalysts, and mixtures thereof.

In a third aspect, an ophthalmic lens includes a film, and the film includes a photochromic dye in a polymer matrix. The polymer matrix includes at least one allophanate or biuret group, and the at least one allophanate or biuret group includes a silane moiety.

Many aspects and embodiments have been described above and are merely exemplary and not limiting. After reading this specification, skilled artisans appreciate that other aspects and embodiments are possible without departing from the scope of the invention. Other features and advantages of the invention will be apparent from the following detailed description, and from the claims.

In one embodiment, a liquid coating composition includes a blend of a polymer matrix resin and a photochromic dye and can be cured in such a way that the photochromic dye is retained in a polymer matrix formed by the polymer matrix resin after curing. The dye has photochromic activity when exposed to UV radiation, rapidly producing a color change. Deactivation of the photochromic dye, with loss of color, happens rapidly with the removal of the irradiating source.

### Polymer Matrix Resins

In one embodiment, the synthesis of a polymer matrix resin begins with poly-hydroxyl functional polymers, such as polyesters, which are reacted with one or more reagents to give resins which contain substituted alkoxy silane groups. In other embodiments, other types of starting resins can be used. Homopolymers or copolymers of polyesters, polyethers, polycarbonates, polyurethanes, polyacrylates, polyolefins, polyamides, and mixtures thereof may be used as a starting resin. In some embodiments, blends of these homopolymers or copolymers may be used. Polymer matrix resins can be linear, branched or hyper-branched and may include random or block copolymers. In one embodiment, a polymer matrix resin can be polyfunctional in any group that will react with isocyanate groups to form silane groups. These include mercapto and amino groups, combinations with each other as well as with hydroxyl groups. Another possible route to silane-functional polymer matrix resins is to have reactive groups on the polymer that can couple with amino or epoxy silanes. These would include isocyanato, epoxy or amino groups.

One skilled in the art would recognize that there are several methods that can be used to attach or build silane functionality into a polymer matrix resin. In one embodiment, coupling to silane ester (—Si—OR) groups provides a level of chain extension and crosslinking. However, too little coupling does not generate the properties of the matrix that provide stable hard films, and too much coupling can provide a hard matrix that is too closely crosslinked, such that the photochromic dye cannot function properly during activation and deactivation. A balance of properties is desired for tuning the performance of each photochromic dye in combination with a particular polymer matrix.

The examples below show one set of polyester-type terminal diols used as a starting point for silane functionalization. More than one equivalent of siloxane per hydroxyl group is made possible by reaction of excess or additional silating agent with other functional groups such as hydroxy, amino, urea and carbamate groups. If an isocyanate-functional silane is used, one can obtain biuret or allophanate structures. This is one method of producing terminal silane functionality greater than two per polymer diol.

In some embodiments, polymers used to produce a polymer matrix resin may include pendant functionality in addition to the terminal functional groups. If a poly-hydroxyl functional polymer, such as a polyester polyol, includes pendant hydroxyl groups, then pendant silane groups may be formed. However, if a high level of pendant silane groups are formed in the polymer matrix resin, the resulting polymer matrix formed upon curing may be too densely crosslinked, inhibiting the electrocyclic transition of the photochromic dye material. A densely crosslinked polymer matrix can have reduced flexibility of its polymer chain segments surrounding the photochromic dye, resulting in higher local viscosities, hindering the mobility of the photochromic dye. In one embodiment, at least 50% of the silane groups in the polymer matrix resin are at terminal positions. In a more particular embodiment, at least 80% of the silane groups in the polymer matrix resin are at terminal positions. In a still more particular embodiment, at least 95% of the silane groups in the polymer matrix resin are at terminal positions. The optimum number of terminal silane groups per polymer is dependent on many factors. Two terminal silane groups, such as trialkoxysilanes, per polymer will produce a polymer matrix resin which will form a film that is hard enough for over coating with another coating, such as a hard coat. In one embodiment, having greater than two terminal silane groups per polymer molecule can provide an even better balance of optical, chemical and physical properties in a film for ophthalmic lenses.

### Photochromic Dyes

Various photochromic dyes may be blended with polymer matrix resins in liquid coating compositions. In one embodiment, a photochromic dye may be an organic compound with an activated absorption maxima in the range of from about 300 to about 1000 nanometers. The organic photochromic dye may be selected from the group consisting of pyrans, oxazines, fulgides, fulgimides, diarylethenes and mixtures thereof.

In one embodiment, a photochromic pyran can be used as a photochromic dye blended with a polymer matrix resin in a liquid coating composition. A photochromic pyran may be selected from the group consisting of benzopyrans, naphthopyrans (e.g., naphtho[1,2-b]pyrans, naphtho[2,1-bpyrans, indeno-fused naphthopyrans and heterocyclic-fused naphthopyrans), spiro-9-fluoreno[1,2-b]pyrans, phenanthropyrans, quinolinopyrans; fluoroanthenopyrans, spiropyrans (e.g., spiro(benzindoline)naphthopyrans, spiro(indoline) benzopyrans, spiro(indoline)naphthopyrans, spiro(indoline)quinolinopyrans and spiro(indoline)pyrans) and mixtures thereof.

In one embodiment, a photochromic oxazines can be used as a photochromic dye blended with a polymer matrix resin in a liquid coating composition. A photochromic oxazine may be selected from the group consisting of benzoxazines, naphthoxazines, and spiro-oxazines (e.g., spiro(indoline)naphthoxazines, spiro(indoline)pyridobenzoxazines, spiro(benzindoline)pyridobenzoxazines, spiro(benzindoline)naphthoxazines, spiro(indoline)benzoxazines, spiro(indoline)fluoranthenoxazine, and spiro(indoline)quinoxazine) and mixtures thereof.

Those skilled in the art will understand that there are many possible combinations of polymer matrix resins and photochromic dyes that may be useful in the liquid coating compositions disclosed herein and that particular combinations of polymer matrix resin and photochromic dye are selected based on the optical, chemical and physical properties of the resulting film. A photochromic dye that works well in one polymer matrix may not work well in a similar, but not identical, polymer matrix. Each photochromic dye or dye set requires some level of matrix “tuning” to provide optimum performance.

### Reactive Solvents

In some embodiments, reactive solvents can be included in the liquid coating composition and may react into the polymer matrix upon curing. In one embodiment, reactive solvents having a structure of R—[—Si(OR′)ₙ(R)ₘ]ₚ with n=1-3, m=3-n and p=1-4, R=linear, branched, cyclic or their combinations of an alkyl group with C1-C20, which may be functionalized with groups such as isocyanate, ester, epoxy, amino, carbamate, urea, amide, phenyl, vinyl, mercapto, halo, etc. and R′=methyl, ethyl, etc. may be used.

Reactive solvents that may be useful in the liquid coating compositions disclosed herein, sometimes known as “silane crosslinkers” (and described here using WACKER silane structural formulae), can include 1,2-bis(triethoxysilyl)ethane, 2-aminoethyl-3-aminopropylmethyldimethoxysilane, 2-aminoethyl-3-aminopropyltrimethoxysilane, 3-(2-aminomethylamino)propyltriethoxysilane, 3-aminopropylmethyldiethoxysilane, 3-aminopropyltriethoxysilane, 3-aminopropyldimethoxymethylsilane, 3-aminopropyltrimethoxysilane, 3-glycidoxypropyltriethoxysilane, 3-glycidoxypropyltrimethoxysilane, 3-glycidoxypropyldimethoxymethylsilane, 3-mercaptopropyltrimethoxysilane, 3-octanoylthio-1-propyltriethoxysilane, 3-ureidopropyltriethoxysilane, 3-ureidopropyltrimethoxysilane, beta-(3,4-epoxycyclohexyl)ethyltrimethoxysilane, beta-(3,4-epoxycyclohexyl)ethyltriethoxysilane, bis(3-triethoxysilylpropyl)amine, bis(3-trimethoxysilylpropyl)amine, cyclohexylmethyldimethoxysilane, dicyclopentyldiethoxysilane, dicyclopentyldimethoxysilane, dipropyldimethoxysilane, ethyltriacetoxysilane, glycidoxymethyltriethoxysilane, glycidoxymethyltrimethoxysilane, isobutyltrimethoxysilane, isooctyltrimethoxysilane, N-(2-aminoethyl)-3-aminopropylmethyldimethoxysilane, N-(2-aminoethyl)-3-aminopropyltriethoxysilane, N-(6-aminohexyl)-aminomethyltrimethoxysilane, N-(n-butyl)-3-aminopropyltrimethoxy-silane, N-beta-(aminoethyl)-gamma-aminopropylmethyldimethoxysilane, N-cyclohexyl-3-aminopropyltrimethoxysilane, N-cyclohexylaminomethyltriethoxysilane, N-cyclohexylaminomethyltrimethoxysilane, N-diethoxy(methyl)silylmethyl-β-methylcarbamate, N-dimethoxy(methyl)silylmethyl-O-methylcarbamate, N-phenyl-gamma-aminopropyltrimethoxysilane, N-trimethoxysilylmethyl-β-methylcarbamate, N-triethoxysilylmethyl-O-methylcarbamate, octylmethyldiethoxysilane, octyltrimethoxysilane, phenyltriethoxysilane, phenyltrimethoxysilane, propylmethyldimethoxysilane, propyltriethoxysilane, propyltrimethoxysilane, tris-[3-(trimethoxysilyl)propyl]-isocyanurate, ureidomethyltrimethoxysilane, vinyldimethoxymethylsilane, vinyltri(2-methoxyethoxy)silane, vinyltriethoxysilane, vinyltrimethoxysilane, and mixtures thereof. In one embodiment, a reactive solvent in the liquid coating composition is selected from the group consisting of 1,2-bis(triethoxysilyl)ethane, 3-ureidopropyltrimethoxysilane, 3-glycidoxypropyldimethoxymethylsilane, cyclohexylmethyldimethoxysilane, ureidomethyltrimethoxysilane, N-cyclohexylaminomethyltriethoxysilane, propyltrimethoxysilane, and mixtures thereof.

### Additives

In some embodiments, liquid coating compositions can contain additional additives such as light stabilizers, anti-oxidants, surfactants, adhesion promoters, crosslinkers, catalysts, and mixtures thereof that may affect the coating process or the optical, chemical or physical properties of the coated lens.

In one embodiment, a light stabilizer can include a UV light absorber a hindered amine light stabilizer (HALS), or a mixture thereof. These light stabilizers can filter harmful UV light and trap free radicals that might form in the liquid coating composition or film. A wide variety of HALS, both unsubstituted and substituted, may be used, including compounds that function as radical scavengers. Examples of HALS include 2,2,6,6-tetramethylpiperperidine, 2,2,6,6-tetramethylpiperperazinone, Tinuvin® (e.g., Tinuvin® 144 and Tinuvin® 622, both available from BASF, Germany), and CYASORB® 3346 (available from Cytec Industries Inc., Woodland Park, N.J.).

### Moisture Cure

In one embodiment, a polymer matrix, which is formed in the presence of a photochromic dye, can be the result of a moisture cure process of chain extension and crosslinking of polymers containing silane groups. Moisture curing of silanes is well known. Disclosed herein is a liquid coating composition that allows for the use of a moisture cure process to form films of photochromic dyes in polymer matrices under mild conditions. These films support reversible and repeatable photochemical reaction of the photochromic dye, as required in commercial ophthalmic lens applications.

### EXAMPLES

The concepts described herein will be further described in the following examples, which do not limit the scope of the invention described in the claims.

### Polymer Matrix Resin Preparation A

### Examples 1 to 7

Examples 1 to 7 (E1 to E7) demonstrate the preparation of silane-terminated polymer matrix resins using various polyester diols in conjunction with isocyanate silanes.

In one embodiment, polyester diol (Stepanol®, Stepan Co., Northfield, Ill.) is placed in a dry glass reactor. The reactor is heated to 110° C. and held until water from the diol has been distilled. The reactor is then cooled to 80° C. where trimethyl orthoacetate (TMOA) is added to capture any remaining water in the reactor. Dibutyl tin dilaurate (DBTDL) is added to the 80° C. reactor followed by the addition of the isocyanato silane over a period of about 30 minutes. 3-isocyanatopropyl triethoxysilane (IPTES) is used in E1, and 3-isocyanatopropyl trimethoxysilane (IPTMS) is used in E2-E7. The isocyanato silane is added in either a single addition (E1 and E3-E7) or with first and second additions (E2). The disappearance of the isocyanate group is monitored by infrared (IR) spectroscopy. When the absorption at or near 2274 cm⁻¹ has disappeared, the reaction is considered complete. If the isocyanate to hydroxyl ratio is greater than 1.0, an allophanate reaction will then take place, continuing to deplete the isocyanate after all the hydroxyl groups have been consumed, resulting in the formation of allophanate groups. The allophanate peak, at roughly 1835 cm⁻¹ in the IR spectra, will begin to appear upon formation of the allophanate groups.

From the ratio of isocyanate to hydroxyl groups, the ratio of terminal silane groups per polymer can be determined. If, for example, the isocyanate to hydroxyl ratio is 2.0, the isocyanate conversion will have reached the point where 50% of the isocyanate groups have reacted. The terminal silane to polymer ratio (—Si(OR′)₃/polymer) is calculated from the isocyanate to hydroxyl ratio. The starting terminal diol polyesters contain 2.0 hydroxyl groups per polymer, both at terminal positions. Reaction of each hydroxyl group with one isocyanato alkyl silane will replace a terminal hydroxyl group with a terminal silane group. After both terminal hydroxyl groups are reacted, a terminal silane to polymer ratio of 2.0 is reached. If less than a full equivalent of isocyanato silane (e.g., IPTES, IPTMS, etc.) is used, then the terminal silane to polymer ratio will be less than 2.0, representing a resin where most of the polymers have reacted twice but there is not enough isocyanato silane to react with all of the terminal hydroxyl groups in the resin.

To achieve a terminal silane to polymer ratio of more than 2.0, one begins by first reacting all of the hydroxyl groups with isocyanato silane (achieving a ratio of 2.0). Additional isocyanato silane then reacts with reactive —NH groups found on the carbamate group that formed in the reaction of isocyanates with hydroxyl groups. This reaction will produce an allophanate structure containing an additional silane moiety. In one embodiment, a terminal silane to polymer ratio of 2.5 would indicate that 100% of the terminal hydroxyl groups have been reacted with isocyanato silane to produce a carbamate silane-terminated polymer and 25% of the carbamate groups have further reacted with another isocyanato silane to form an allophanate containing an additional silane moiety.

In one embodiment, a first isocyanate charge will be approximately one equivalent based on hydroxyl groups. In this embodiment, a second charge of the isocyanate silane is then added to form the allophanate groups. To ensure that all of the isocyanate has been converted, a charge of n-butanol or methanol is added at the end of the process. Methylethyl ketone (MEK) is used to wash any residual isocyanato silane from the delivery vessel or syringe into the reactor. Table 1 summarizes the ingredients (in grams) used for the preparation of the polymer matrix resins of E1 to E7 and the terminal silane to polymer ratio of the resulting polymer matrix resins.

TABLE 1

| | E1 | E2 | E3 | E4 | E5 | E6 | E7 |
|---|---|---|---|---|---|---|---|
| Stepanol ® | PD | PD | PS 3152 | PS 3152 | PS 2002 | PN 110 | PS 1752 |
| polyol type | 200-LV | 200-LV | | | | | |
| Polyol amount | 45.34 | 1950.80 | 35.69 | 19.99 | 47.85 | 56.03 | 25.41 |
| TMOA-1^{st} add. | 0.91 | 7.74 | 0.71 | 0.40 | 0.96 | 1.12 | 0.51 |
| DBTDL | 0.002 | 0.465 | 0.001 | 0.001 | 0.002 | 0.002 | 0.001 |
| TMOA-2^{nd} add. | 1.81 | — | 1.43 | 0.80 | 1.91 | 2.24 | 1.02 |
| MEK-1^{st} add. | 9.07 | — | 7.14 | 4.00 | 9.57 | 11.21 | 5.08 |
| IPTES | 40.16 | — | — | — | — | — | — |
| IPTMS-1^{st} add. | — | 1450.50 | 50.74 | 23.61 | 33.97 | 22.67 | 16.45 |
| MEK-2^{nd} add. | 1.81 | — | 1.43 | 0.80 | 1.91 | 2.24 | 1.02 |
| IPTMS-2^{nd} add. | — | 363.0 | — | — | — | — | — |
| n-butanol | 14.51 | — | 11.42 | 6.40 | 15.31 | 17.93 | 2.0 |
| methanol | — | 59.47 | — | — | — | — | — |
| —Si(OR′)₃/polymer | 2.0 | 2.5 | 2.0 | 3.2 | 2.0 | 2.0 | 1.9 |

### Polymer Matrix Resin Preparation B

### Examples 8 and 9

Examples 8 and 9 (E8 and E9) demonstrate the preparation of silane-terminated polymer matrix resins using a polyester diol in conjunction with isophorone diisocyanate (IPDI) and N-cyclohexylaminomethyltriethoxysilane.

In one embodiment, polyester diol (Stepanol® PD 200-LV) is placed in a dry glass reactor. The reactor is heated to 110° C. and held until water from the diol has been distilled. The reactor is then cooled to 80° C. where TMOA is added to capture any remaining water in the reactor. DBTDL is added to the 80° C. reactor followed by an addition of IPDI over a period of about 30 minutes. The amount of diisocyanate added is targeted to be roughly two equivalents of isocyanate groups per one equivalent of isocyanate reactive groups (hydroxyl, mercapto, etc). Reaction of the isocyanate group is followed by titration using the dibutyl amine method. When the desired level of isocyanate conversion is reached, the second stage of the process is initiated. At this point the polymer is mostly terminated with isocyanate groups.

The second stage of the process is to add a compound or compounds which will react with the remaining isocyanate groups. In one embodiment, an amino silane, N-cyclohexylaminomethyltriethoxysilane (Geniosil® XL-926, Wacker Chemie AG, Germany), is added and reacts with the remaining isocyanante to form terminal triethoxysilane groups. Adding other functional groups to the polymer matrix resin is also possible. In one embodiment, dimethylol propionic acid (DMPA) is added to produce pendant acid groups on the polymer backbone that can aid in film adhesion. In addition to these acid groups, however, DMPA also adds pendant hydroxyl groups to the polymer, which can further react if left uncapped. An isocyanato silane, such as IPTMS, can be used to cap these pendent hydroxyl groups. In one embodiment, an additive, propane diol methyl ether acetate, that aids in flow and leveling of the liquid coating composition can also be used. A solvent can be used to wash any residual reagent from the delivery vessel or syringe into the reactor. Table 2 summarizes the ingredients (in grams) used for the preparation of the polymer matrix resins of E8 and E9 and the terminal silane to polymer ratio of the resulting polymer matrix resins.

TABLE 2

| | E8 | E9 |
|---|---|---|
| Polyester diol (Stepanol ® PD 200-LV) | 346.43 | 157.01 |
| DBTDL | 0.062 | 0.038 |
| MEK-1^{st} addition | 155.34 | 82.51 |
| IPDI | 171.36 | 104.87 |
| MEK-2^{nd} addition | 8.63 | 4.58 |
| DMPA | — | 13.14 |
| N-Cyclohexylaminomethyltriethoxysilane | 85.00 | 52.00 |
| (Geniosil ® XL-926) | | |
| IPTMS | — | 23.2 |
| Propane diol methyl ether acetate | 438.4 | 262.7 |
| —Si(OR′)₃/polymer | 1.6 | 1.6 |

### Lens Preparation

Lenses are cleaned with mild soap and water, then rinsed with water followed by deionized water. The lens is then placed in an ethyl alcohol/water bath for at least 5 minutes. The bath contains 70-80% ethanol. The lens is then dried with compressed air. Lens are not dried the in the oven because the small amount of surface water that remains on the lens will also aid in moisture curing and may aid in adhesion promotion.

Handling of the lens should be by the edges only and in a way not to transfer grease or oil from hands to the lens surface.

### Preparation of Liquid Coating Composition

Formulating the liquid coating composition of the polymer matrix resin with photochromic dye, and any additional additives, is preferably done in three stages. A first solution of photochromic dye in solvent is prepared. A second solution of polymer matrix resin is prepared, which may contain additional reactive solvents and additives. The two solutions are then combined to form the liquid coating composition.

### Photochromic Dye Solution

Most photochromic dyes have limited solubility in organic solvents. Cyclohexanone makes a reasonable solvent with a saturation concentration of up to about 20% for some dyes. For liquid coatings on polycarbonate lenses, the use of toluene is preferred. It is important to solubilize the dye completely in the solvent since un-dissolved dye is photochromically inactive and can cause grit issues in the coating. The dye must also be soluble in the cured film. Crystallization or insolubility of the dye in the matrix is indicated by haze in the coated film.

In one embodiment, the photochromic dye solution is prepared by first adding, 1.1516 g of a pyran-based photochromic dye, Reversacol™ Volcanic Grey (Vivimed Labs Europe, Ltd., UK) to 7.5349 g of either cyclohexanone or toluene to form a 13.26% solution (8.6865 g total). This is stirred until the Reversacol™ Volcanic Grey is completely in solution.

### Polymer Matrix Resin Solution

In one embodiment, a polymer matrix resin solution, using polymer matrix resin E2 from Table 1, can be prepared using the ingredients in Table 3. This solution is mixed, in the absence of water (e.g., vapor), for 6-12 hours.

TABLE 3

| | |
|---|---|
| Polymer Matrix Resin E2 | 24.4388 g |
| Tetrahydrofuran | 8.3849 g |
| Dibutyltindiacetate | 0.2237 g |
| Water | 0.2666 g |
| Total | 33.3140 g |

### Liquid Coating Composition

The photochromic dye solution (8.6865 g) is added slowly into the polymer matrix resin solution (33.3140 g) and mixed for at least 8 hours. The resulting liquid coating composition, about 4.5 weight % dye (based on total solids content), is then ready for spin coating on lenses. An open container of this liquid coating composition (approximately 20-30 cPs, kept stirring), can remain below 30 cPs for several weeks in air if kept below 3% humidity.

### Spin Coating

20.0 ml of the photochromic dye-containing liquid coating composition is filtered through a 2.7 to 5.0 micron syringe filter. This filtered solution is enough to spin coat three 70 mm lenses. The filtered coating composition should appear clear before proceeding. Un-dissolved dye particles will cause haze in the coated film and affect the optical properties of the lens. Spin coating can be done in one or more stages. In one embodiment, for a two-stage process, about 3 ml of the photochromic dye-containing liquid coating composition is coated on a lens spinning at 600 rpm, forming a coating on the lens in less than one second, and spun for 2 minutes, allowing enough solvent to evaporate so that the coating will not flow. After the 2 minute spin, the coating forms a thin transparent film which is quite smooth. This film will immediately begin to absorb water vapor which starts the moisture cure.

The coated lens is then place in a 120° C. oven in a moist environment (an open beaker of water in the oven) for 15 minutes to accelerate the moisture cure. At this point, most of the remaining solvent has evaporated and the film is partially cured. The lens is then removed, allowed to cool to approximately room temperature and recoated with another 3 ml of the same solution. The second coating will penetrate into the partially cured film so that upon final curing there is no discernable interface between the first and second coating layers. The lens is replaced in the 120° C. oven for another 1 hour to complete the moisture curing. The total film weight is between about 50 and about 70 mg. A film of approximately 26.1 microns is formed using this two-stage process.

In another embodiment, if only the first spin coating described above is used for a one-stage process, followed by complete curing in the oven, a film of approximately 12.4 microns is formed.

After cooling, the lens is ready for additional coating such as a hard coat.

### Photochromic Properties

Lenses coated with photochromic films, as disclosed herein, can be exposed to natural sunlight which activates the photochromic dye in the film and darkens the lens. The effect of UV radiation on the darkening of the coated lenses can be measure by exposing the coated lenses to UV radiation in a Cyrel® 1215 Exposure Unit (E.I. DuPont de Nemours and Company, Wilmington, Del.) outfitted with high intensity UV fluorescent tubes (λₘₐₓ=355 nm), at a distance of 1.5 inches from the lens surface. Before exposure, the lens is placed in a Hewlett-Packard model 8453 UV-Visible Spectrometer with an Agilent model G1103A detector (Agilent Technologies, Santa Clara, Calif.) where a UV-Visible spectrum of the pre-activation coated lens is recorded (with the lens temperature between 24 and 25° C.). The lens is then exposed to UV radiation in the Cyrel® 1215 Exposure Unit for 2 minutes, after which it is quickly removed and again placed in the spectrometer to measure the UV-visible spectrum of the fully activated coated lens. A UV-visible spectrum, between 375 nm and 850 nm is taken every 10 seconds, initially, and then with increasing periodicity until the percent transmission (% T) is about 80%.

The transmission at the λₘₐₓ for the Reversacol™ Volcanic Grey photochromic dye is approximately 583 nm. The percent transmission data, at this wavelength, was plotted versus time. Table 4 is a tabulation of the data derived from these plots. Comparative Example 1 (CE1) is a commercial polycarbonate (PC) lens with a Transition® 5 lens treatment (Transitions Optical, Inc., Pinellas Park, Fla.) having a refractive index (R.I.) of 1.59. Examples 10-15 (E10-E15) include films coated on various 70 mm lenses with different refractive indices.

TABLE 4

| | | Pre- activation | Fully activated | T_{3/4} |
|---|---|---|---|---|
| | R.I. | (% T) | (% T) | (sec) |
| CE1 (control) | 1.59 | 100.0 | 17.80 | 215 |
| E10 | 1.498 | 100.0 | 6.18 | 262 |
| E11 | 1.59 | 100.0 | 7.98 | 268 |
| E12 | 1.59 | 99.9 | 11.70 | 202 |
| E13 | 1.67 | 100.0 | 6.01 | 290 |
| E14 | 1.67 | 100.0 | 7.61 | 219 |
| E15 | 1.74 | 100.0 | 7.66 | 203 |

The data provide evidence that fully activated dyes in the photochromic films give improved % T (darker lenses) compared to CE1. Fade rates, measured as T_{3/4}, are comparable to CE1.

Note that not all of the activities described above in the general description or the examples are required, that a portion of a specific activity may not be required, and one or more further activities may be performed in addition to those described. Still further, the order in which activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that one or more modifications or one or more other changes can be made without departing from the scope of the invention as set forth in the claims below. Accordingly, the specification and figures are to be regarded in an illustrative rather than a restrictive sense and any and all such modifications and other changes are intended to be included within the scope of invention.

Any one or more benefits, one or more other advantages, one or more solutions to one or more problems, or any combination thereof has been described above with regard to one or more specific embodiments. However, the benefit(s), advantage(s), solution(s) to problem(s), or any element(s) that may cause any benefit, advantage, or solution to occur or become more pronounced is not to be construed as a critical, required, or essential feature or element of any or all of the claims.

It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any sub-combination. Further, reference to values stated in ranges include each and every value within that range.

What is claimed is:

1. A liquid coating composition comprising a blend of a polymer matrix resin and a photochromic dye, wherein:
the polymer matrix resin comprises silane groups; and
at least 50% of the silane groups in the polymer matrix resin are at terminal positions.

2. The liquid coating composition of claim 1, wherein the polymer matrix resin further comprises at least one allophanate or biuret group, wherein the at least one allophanate or biuret group is at a terminal position.

3. The liquid coating composition of claim 2, wherein the at least one allophanate or biuret group comprises a silane moiety.

4. The liquid coating composition of claim 1, wherein the polymer matrix resin comprises a homopolymer or copolymer selected from the group consisting of polyesters, polyethers, polycarbonates, polyurethanes, polyacrylates, polyolefins, polyamides, and mixtures thereof.

5. The liquid coating composition of claim 4, wherein the polymer matrix resin comprises a polyester.

6. The liquid coating composition of claim 1, wherein the photochromic dye is selected from the group consisting of pyrans, oxazines, fulgides, fulgimides, diarylethenes and mixtures thereof.

7. The liquid coating composition of claim 1, wherein at least 80% of the silane groups in the polymer matrix resin are at terminal positions.

8. The liquid coating composition of claim 7, wherein at least 95% of the silane groups in the polymer matrix resin are at terminal positions.

9. The liquid coating composition of claim 1 further comprising a reactive solvent.

10. The liquid coating composition of claim 9, wherein the reactive solvent is selected from the group consisting of 1,2-bis(triethoxysilyl)ethane, 3-ureidopropyltrimethoxysilane, 3-glycidoxypropyldimethoxymethylsilane, cyclohexylmethyldimethoxysilane, ureidomethyltrimethoxysilane, N-cyclohexylaminomethyltriethoxysilane, propyltrimethoxysilane, and mixtures thereof.

11. The liquid coating composition of claim 1 further comprising an additive selected from the group consisting of light stabilizers, anti-oxidants, surfactants, adhesion promoters, crosslinkers, catalysts, and mixtures thereof.

12. The liquid coating composition of claim 1, wherein the liquid coating composition is moisture curable.

13. A film comprising a photochromic dye in a polymer matrix, wherein the polymer matrix comprises at least one allophanate or biuret group and wherein the at least one allophanate or biuret group further comprises a silane moiety.

14. The film of claim 13, wherein the polymer matrix comprises a homopolymer or copolymer selected from the group consisting of polyesters, polyethers, polycarbonates, polyurethanes, polyacrylates, polyolefins, polyamides, and mixtures thereof.

15. The film of claim 14, wherein the polymer matrix comprises a polyester.

16. The film of claim 13, wherein the photochromic dye is selected from the group consisting of pyrans, oxazines, fulgides, fulgimides, diarylethenes and mixtures thereof.

17. The film of claim 13 further comprising an additive selected from the group consisting of light stabilizers, anti-oxidants, surfactants, adhesion promoters, crosslinkers, catalysts, and mixtures thereof.

18. An ophthalmic lens comprising a film, wherein:
the film comprises a photochromic dye in a polymer matrix;
the polymer matrix comprises at least one allophanate or biuret group; and
the at least one allophanate or biuret group further comprises a silane moiety.
